(19) United States
(12) Patent Application Publication
(10) Pub. No.: US 2009/0097265 A1
(43) Pub. Date: Apr. 16, 2009

(54) LIGHT SOURCE MODULE

(75) Inventors: Chih-Hsien Sun, Chu-Nan (TW); Ching-Chung Nien, Chu-Nan (TW); Hung-Kuang Hsu, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/057,699

(22) Filed: Mar. 28, 2008

(30) Foreign Application Priority Data
Oct. 11, 2007 (CN) 200710201996.2

(51) Int. Cl. F21V 29/00

(52) U.S. Cl. 362/373

(57) ABSTRACT

The light source module (10) includes a circuit board (11), a heat dissipating module (13) and a plurality of light emitting members (121). The circuit board defines a first surface 112 for supporting the plurality of light emitting members and an opposite second surface (114) for supporting the heat dissipation module. The heat dissipating module includes a base (1312), a plurality of heat dissipation fins (1313) and a plurality of heat pipes (132). The base has a top surface (1316) and an opposite bottom surface (1315). The plurality of heat dissipation fins are protruded upwardly from the top surface of the base. A plurality of grooves (1314) are defined in the bottom surface of the base. The heat pipes are received in the plurality of grooves of the base respectively. Each of the heat pipes includes a flat sidewall (1321) and an arc-shaped sidewall (1322).

### BACKGROUND

1. Technical Field

The present invention generally relates to light source modules, and particularly to a light source module with a heat dissipation ability.

2. Description of Related Art

Light emitting diodes (LEDs) are commonly used as light sources in applications such as traffic lights, billboards, displays and so on. The LED has several advantages over incandescent and fluorescent lamps, which are high brightness, long lifespan and low-power consumption. Moreover, a light intensity of the LED is stable under various temperatures, as disclosed in a paper on IEEE Transactions on Power Electronics, Vol. 41, No. 7, titled “A Novel Temperature-Stable Light-Emitting Diode”, published by Yukio Tanaka et al. in July, 1994, the disclosure of which is incorporated herein by reference.

Referring to FIG. 5, when the LED emits light, heat is accordingly generated. Generally, a light source module 100 includes a circuit broad 101, and a plurality of LEDs 102 and a heat dissipation module 103 disposed on two opposite sides of the circuit broad 101. A circuit layer is form on a surface of the circuit broad 101 for electrically connecting with the LEDs 102. The heat dissipation module 103 is made of metal, such as aluminum or copper, and includes a base 1031 and a plurality of heat dissipation fins 1032 protruding from one end of the base 1031. The LEDs 102 are located on an opposite end of the base 1031 from the heat dissipation fins 1032. However, the LEDs 102 is made to be more powerful while maintaining a smaller size. Hot spot is formed between each of the LEDs 102 and the base 1031 and heat generated in the hot spot needs to be transferred to the cooling area of the heat dissipation module 103. Therefore, the heat flux density between the hot spot and the cooling area of the heat dissipation module 103 is increased.

For the foregoing reasons, therefore, it is desired to devise a light source module which can overcome the above-mentioned problems.

### SUMMARY

The present invention relates to a light source module. According to a preferred embodiment of the present invention, the light source module includes a circuit broad, and a heat dissipation module and a plurality of light emitting members located on two opposite sides of the circuit broad. The heat dissipation module includes a base, a plurality of heat dissipation fins and a plurality of heat pipes. The base has a top surface and an opposite bottom surface. A plurality of grooves are defined in the bottom surface of the base for receiving the plurality of heat pipes therein, respectively. Each of the heat pipes has a flat sidewall and an arc-shaped sidewall. The plurality of heat dissipation fins protrude upwardly from the top surface of the base. The plurality of light emitting members are electrically connected with the circuit broad and thermally contacted with the flat sidewall of each of the heat pipes.

Other advantages and novel features of the present invention will become more apparent from the following detailed description of preferred embodiment when taken in conjunction with the accompanying drawings, in which:

### BRIEF DESCRIPTION OF THE DRAWINGS

FIG. 1 is a front elevational view of a light source module in accordance with the present embodiment of the present invention;

FIG. 2 is a left side elevational view of the light source module of FIG. 1

FIG. 3 is a cross-sectional view of the light source module of FIG. 1;

FIG. 4 is an exploded view of the light source module of FIG. 3; and

FIG. 5 is a front elevational view of a light source module in accordance with related art.

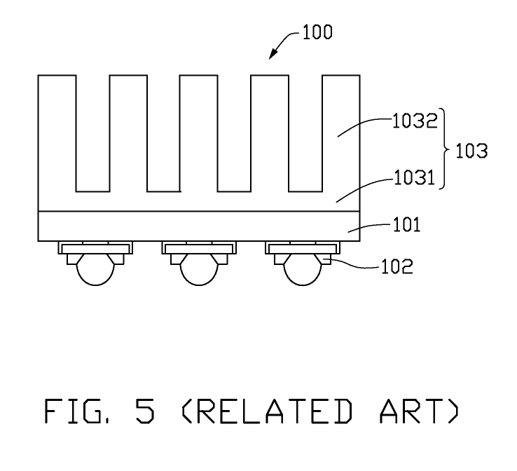

### DETAILED DESCRIPTION OF THE INVENTION

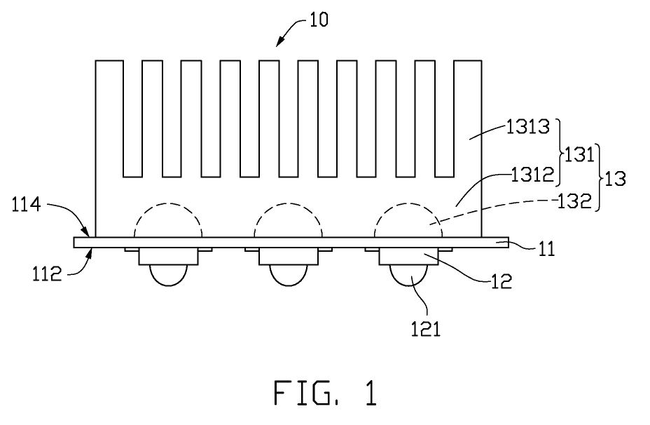

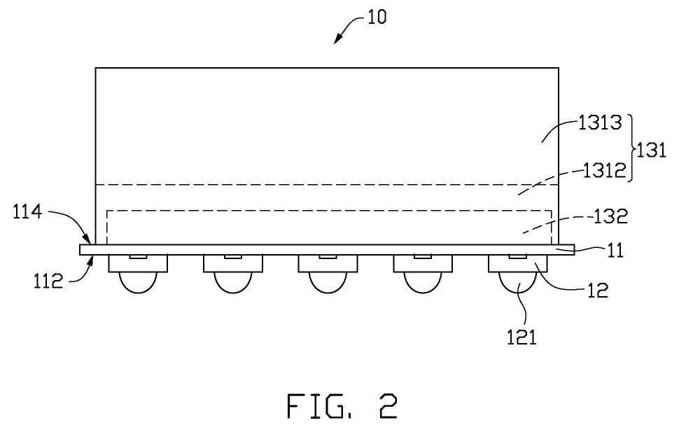

Referring to FIG. 1 and FIG. 2, a light source module 10 includes a circuit broad 11, and a light emitting module 12 and a heat dissipation module 13. The light emitting module 12 is disposed on one end of the circuit board 11 and the heat dissipation module 13 is disposed on the other end of the circuit board 11.

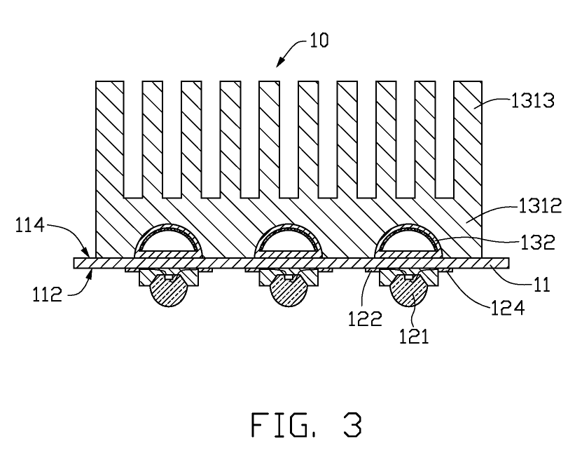

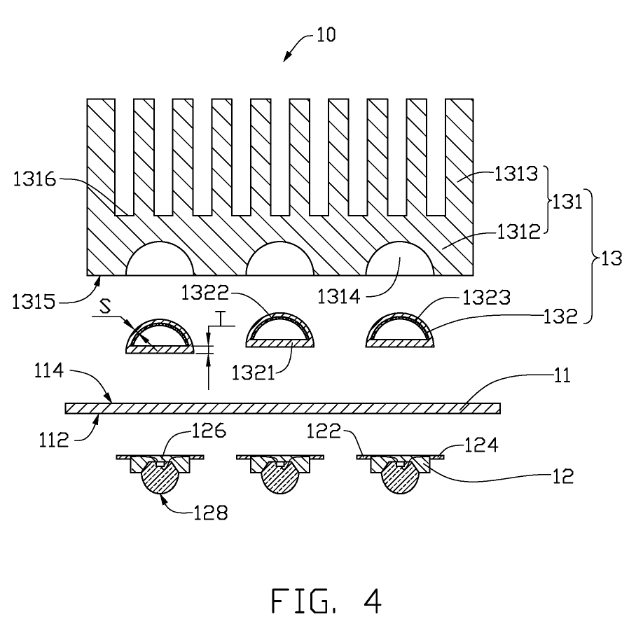

Referring to FIG. 3 and FIG. 4, the circuit broad 11 is planar and thin. The circuit broad 11 includes a first surface 112 and an opposite second surface 114. An electrical circuitry (not shown) is formed on the first surface 112 of the circuit board 11. The light emitting module 12 is attached to the first surface 112 and is electrically connected with the circuitry of the circuit board 11. The circuit broad 11 is preferably a metal core printed circuit board (MCPCB). To form the MCPCB, a planar-shaped metal plate made of aluminum (Al) is used. Alternatively, the metal plate can be made of other materials having high heat conductivity, such as copper (Cu) or its alloys. An insulating layer is then formed on the first surface of the metal plate, and can be coated with a copper foil layer by the processes of sputtering, hot-press, electoless copper deposition or electrodeposition. Finally, the electrical circuitry is formed by photoresist coating, exposing and etching the copper foil layer. It is to be understood that the circuit broad 11 can be other types of printed circuit boards, such as metal base printed circuit boards, ceramic base printed circuit boards and so on.

The light emitting module 12 includes a plurality of light emitting diodes (LEDs) 121 arranged in a matrix. The LED array includes three LED lines (shown in FIG. 1) and five LED rows (shown in FIG. 2). The LEDs 121 in this embodiment are surface-mount LEDs. Each of the surface-mount LEDs 121 includes an encapsulation, an LED chip hermetically received in the encapsulation, and a first electrode 122 and a second electrode 124 electrically connected with the LED chip. When assembled, each surface-mount LED 121 is attached to the first surface 112 of the circuit broad 11 and is electrically connected with the electrical circuitry of the circuit broad 11 through the first and second electrodes 122, 124.

The heat dissipation module 13 is arranged on the second surface 114 of the circuit board 11. The heat dissipation module 13 includes a heat sink 131 and a plurality of heat pipes 132 extending through the heat sink 131. The heat sink 131 includes a planner-shaped base 1312 and a plurality of heat dissipation fins 1313 parallel to each other. The base 1312 includes a bottom surface 1315 and an opposite top surface 1316. The size of the base 1312 is substantially equals to smaller than that of the circuit broad 11. The bottom surface 1315 of the base 1312 is thermally attached to the second surface 114 of the circuit board 11 and preferably with a thermal interface material applied therebetween to thereby improve a heat transfer efficiency. The heat dissipation fins 1313 extend upwardly and perpendicularly from the top surface 1316 of the base 1312. A plurality of grooves 1314 are defined in the bottom surface 1315 of the base 1312 for receiving the plurality of heat pipes 132 therein. The plurality of heat dissipation fins 1313 are integrally formed with the base 1312 as a monolith piece, which provide a large heat dissipation area for the LEDs 121. The heat absorbed by the heat pipes 132 can be quickly transferred to the heat dissipation fins 1313 for further dissipation. The heat dissipation fins 1313 can be made of a highly thermally conductive material, such as copper and its alloys.

Each of the heat pipes 132 is semicircular shaped, and includes a hollow and vacuumed pipe body containing fluids, such as water or alcohol therein. The pipe body of the heat pipe 132 includes a flat sidewall 1321 and an arc-shaped sidewall 1322. Adjacent to an inner surface of the arc-shaped sidewall 1322 of the pipe body is a wick structure 1323, which is made of sintered power or screen mesh. The flat sidewall 1321 of each of the heat pipe 132 thermally contacts the second surface 114 of the circuit board 11 and forms an evaporation section of the heat pipe 132, and the arc-shaped sidewall 1322 of each of the heat pipe 132 thermally contacts an inner surface of a corresponding groove 1314 and forms a condensing section of the heat pipe 132. The flat sidewall 1321 of the heat pipe 132 has a larger thickness T than the arc-shaped sidewall 1322 of the heat pipe 132 which has a thickness S. When assembled, the heat pipes 132 are fixedly assembled to the base 1312 by soldering, and the arc-shaped sidewalls 1322 of the heat pipes 132 are received in the grooves 1314 of the base 1312 respectively with the flat sidewalls 1321 facing the LEDs 121. To reduce a thermal resistance between the heat dissipation module 13 and the light emitting module 12, a thermal interface material, such as thermal grease, may be applied between an outer surface of the flat sidewall 1321 of the heat pipe 132 and the second surface 114 of the circuit board 11. In the same way, the thermal interface material may be applied between an outer surface of the arc-shaped sidewall 1323 of the heat pipe 132 and the inner surface of the groove 1314 of the base 1312.

During operation, the evaporator section (flat sidewall 1321) of the heat pipe 132 is placed in thermal contact with the LEDs 121. The working medium contained in the evaporator section of the heat pipe 132 is vaporized into vapor upon receiving the heat generated by the LEDs 121. Then, the vaporized vapor moves via a space between the flat sidewall 1321 and the arc-shaped sidewall 1322 of the heat pipe 132. After the vapor releases the heat carried thereby and condensed into condensate in the condenser section (arc-shaped sidewall 1322), the condensate is brought back by the wick structure 1323 of the condenser section to the evaporator section of the heat pipe 132 for being available again for evaporation. The thickness of the flat sidewall 1321 of the heat pipe 132 is larger than the thickness of the arc-shaped sidewall 1322 of the heat pipe 132, which increases the heat absorbing ability of the evaporator section of the heat pipe 132 from the LEDs 121. Thus, the heat transfer efficiency of the heat pipe 132 is increased. In addition, an outer surface of the arc-shaped sidewall 1312 of each of the heat pipes 132 intimately contacts with the inner surface of the groove 1314 of the heat sink 131, which provides a large contacting area between the condenser section of the heat pipe 132 and the heat sink 131, thereby increasing the heat conducting ability of the condenser section of the heat pipe 132. Perfectly, a material of the pipe body of the heat pipe 132 is selected from a material having a high thermal conductivity and a relatively low hardness, such as aluminum, and the material of the base 1312 of the heat sink 131 is selected from a material having a high thermal conductivity and a high hardness, such as copper, such that the heat pipe 131 and the heat sink 131 can integrated to each other better.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A light source module, comprising:
a circuit broad;
a heat dissipation module located on one side of the circuit broad, comprising a base, a plurality of heat dissipation fins and a plurality of heat pipes, the base having a top surface and an opposite bottom surface, a plurality of grooves defined in the bottom surface of the base, the plurality of heat pipes received in the plurality of grooves of the base respectively, each of the heat pipes having a flat sidewall and an arc-shaped sidewall, the plurality of heat dissipation fins protruding upwardly from the top surface of the base; and
a plurality of light emitting members located on another opposite side of the circuit board, the plurality of light emitting members electrically connected with the circuit broad and thermally contacted with the flat sidewall of the heat pipes.

2. The light source module as described in claim 1, wherein the flat sidewall of each of the heat pipe has a larger thickness than the arc-shaped sidewall.

3. The light source module as described in claim 1, wherein a cross section of at least one heat pipe of the plurality of heat pipes is semicircular in shape.

4. The light source module as described in claim 1, wherein an outer surface of the arc-shaped sidewall of each of the heat pipes is in thermal contact with an inner surface of a corresponding groove of the base.

5. The light source module as described in claim 1, wherein a thermal interface material is applied between an outer surface of the arc-shaped sidewall of each of the heat pipes and an inner surface of a corresponding groove of the base.

6. The light source module as described in claim 1, wherein an outer surface of the flat sidewall of each of the heat pipes is in thermal contact with the circuit broad.

7. The light source module as described in claim 1, wherein a thermal interface material is applied between an outer surface of the flat sidewall of the heat pipe and the circuit broad.

8. The light source module as described in claim 1, wherein a wick structure is formed on an inner surface of the arc-shaped sidewall of each of the heat pipes.

9. The light source module as described in claim 1, wherein the heat pipe is made of aluminum, and the base is made of copper.

10. The light source module as described in claim 1, wherein the plurality of light emitting members include a plurality of light emitting diodes.

11. A light source module, comprising:
a plurality of light emitting members; and
a heat dissipation module located on one side of the plurality of light emitting members for heat dissipation, the heat dissipation module comprising a base and a plurality of heat pipes, the base having a top surface and an opposite bottom surface, a plurality of grooves for respectively receiving the plurality of heat pipes defined in the bottom surface of the base, each of the heat pipes having an arc-shaped sidewall in thermal contact with an inner surface of the groove of the base and a flat sidewall facing to one of the plurality of light emitting members.

12. The light source module as described in claim 11, wherein the plurality of light emitting members include a plurality of light emitting diodes.

13. The light source module as described in claim 11, wherein the flat sidewall of each of the heat pipes has a larger thickness than the arc-shaped sidewall.

14. The light source module as described in claim 11, wherein a cross section of each of the heat pipes is semicircular in shape.
